(19) United States
(12) Patent Application Publication
(10) Pub. No.: US 2005/0034556 A1
(43) Pub. Date: Feb. 17, 2005

(54) Manual Handle Apparatus

(76) Inventor: Kelley Pate, Franktown, CO (US)

Correspondence Address: ROGER A JACKSON, ESQ, 800 PENNSYLVANIA, SUITE 1504, DENVER, CO, 80203-3185, US

(21) Appl. No.: 10/604,702

(22) Filed: Aug. 11, 2003

(51) Int. Cl. G05G 1/10

(52) U.S. Cl. 74/552

(57) ABSTRACT

A manual handle apparatus and method for use in selectively setting at least one of a number of vise jaws to clamp and unclamp a workpiece in a vise having a base utilizing a vise shaft that converts rotational motion into relative axial movement of the vise jaws. The handle includes a disc, a disc face, a disc annular surface, an outer corrugated periphery handgrip, and an axial aperture therethrough that rotatably drives the vise shaft. Also, a hub including a proximal end and a distal end, the hub proximal end is adjacent to the annular surface, with the hub including an aperture therethrough coaxial to the disc aperture. The hub distal end faces the vise, the hub also having an outer surface not extending to the disc periphery thus forming an annular recess between the annular surface and the hub outer surface.

### TECHNICAL FIELD

The present invention generally relates to handles for the opening and closing of a vise utilizing a manually hand operated apparatus that imparts shaft rotational motion into relative vise jaw movement to a fixed vise jaw for the purpose of clamping or holding a workpiece. More particularly, the present invention relates to a manual handle apparatus that is relatively small in size for use with a low profile machinists vise, wherein the handle rotationally engages a vise shaft allowing for one handed operation to quickly open or close the vise jaws and to limit a rotational torque from the user's hand on the vise shaft resulting that the amount of clamping force from the vise jaws placed upon the workpiece being limited by a frictional grip of the user's hand on the handle.

### BACKGROUND OF INVENTION

Vises commonly used in the machinists art being typically used with a milling machine, drill press, hobbing machine, grinding machine, and the like, are carried and attached onto a particular machines support table. The aspect of a machinists vise is that the vise should be as low as possible to the support table so that the resultant work piece that is mounted within the vice is as close to the support table as possible which can minimize machining stresses and deflections for increased accuracy of machining. Frequently, due to the low profile of the machinists vise and the resulting close proximity of the rotational axis of the vise shaft to the support table or vise mounting surface, the handle that is rotatably engaged to the vise shaft can typically only rotate the vise shaft substantially less than a full turn before the handle engages the vise mounting surface. At this point, the handle typically must be reoriented on the vise shaft to provide each subsequent limited rotation of the vise shaft. This results in the situation where the relative movement of the movable jaw to the fixed jaw is slow and time consuming to the user. In addition, control of the application of rotational torque upon the vise shaft to control workpiece clamping forces is also cumbersome as typically a separate handle adapter is required with a special torque controlling wrench being required to be used, which also further adds to the time in not only positioning the vise jaws to clamp the workpiece but also to appropriately clamp the workpiece between the vice jaws with the desired or selected amount of clamping force. The amount of clamping force between the vise jaws is important as too light of clamping force could result in the workpiece dislodging from the vise resulting in scrap workpieces and possible injury to the user and too high of clamping force could distort the workpiece also resulting in scraping the workpiece. As is typical in machining operations, multiple like parts have the same machine operations performed on them which requires removing a machined workpiece from the vise and replacing it with a workpiece that needs machining in the vise, with this workpiece vise replacement being repeated many times, thus any amount of time savings in workpiece replacement within the vise with a lower workpiece scrap rate is of great benefit.

The aforementioned problem has been recognized in the prior art, specifically referring to the U.S. Pat. No. 4,593,892 to Terstegge that discloses a machinist's vise handle that is designed to quickly speed long closing and opening distances of the vise jaws by the use of an angled handle, although the arrangement in this prior art reference does not appear to be the most ergometric as the user's wrist must be placed at a sharp angle, which is undesirable for repetitive motions, specifically referencing FIGS. 1, 4, 5, and 6. Additionally, in Terstegge there is no torque control for the machinists vise handle while in the quick speed position for closing and opening of the vise jaws, applying torque to the vise shaft requires that the handle be removed and repositioned to impart a desired amount of rotational torque upon the vise shaft for clamping the workpiece inbetween the vise jaws, and in this area a simple perpendicular handle is used to add rotational torque to the vise shaft which will vary among and in proportion to the arm strength of the various users. Another prior art example is given in U.S. Pat. No. 6,415,683 B1 to Fortin et al. that discloses a multiuse workbench with vise having a corresponding handle that is formed of a circular segment disc with a rotating crank or knob. Although Fortin et al. utilizes the rotating crank that is rotatably engaged with the circular segment to do the job at speed cranking for quick opening and closing of the vise, there is no use of the handle for torque control of the vise shaft, which is accommodated separately through a clutch in the vise. A further example in the prior art is in U.S. Pat. No. 5,683,077 to Fink et al. that discloses a vice handle torque control utilizing a conventional clutching mechanism that “clicks” on the preset amount of rotational torque is achieved with a ratchet to allow loosening of the vise, however, the handle uses a conventional, perpendicular to the axis rotation extension for any loosening thus there is no teaching related to a speed closing and opening of the vise jaws with the use of a conventional torque wrench. Similarly, in U.S. Pat. No. 6,347,792 B1 to O'Brien a conventional torque wrench is adapted to be used on vise shaft in a ratcheting arrangement which has no design provision for the speed opening and closing of the vise jaws and requires the addition and removal of the torque wrench for space and a clearance purposes as it has a significant handle extension that can get in the machinist's way.

There are several U.S. Design patents that pictorially disclose generic handwheels; starting with U.S. Design Pat. No. D463,967 S to Bertani that discloses a hand wheel with a crank, however, showing a tapered smooth outer periphery and without a hex rotational drive axially positioned through the entire handle to allow axial positioning, while this reference may be adept at the possibility of speed opening and closing of vise jaws there is no provision for easy removal of the hand wheel from the shaft or any provision for rotational torque control. Similarly, in U.S. Design Pat. No. D204,138 to Olson, disclosed is a tuning knob for a television receiver having an outer periphery with a gripping surface and an axially very short crank, however, there is no provision for quick and easy removal of the knob from the television receiver, nor is there a structural provision for speed closing or opening that could apply to vise jaws with the axially short crank structure. Further, in French Patent No. FR2789617 to Perinetti disclosed is a disc shaped handle having a periphery with a hand gripping surface, the disc also includes a series of interchangeable hubs with differing internal diameters to give the disc the ability to engage different configuration shafts, however, there is no crank for speed spinning of the disk nor is there a handhold to make the disc easily removable from the shaft.

What is needed is a manual handle apparatus that facilitates a quick opening and closing of a machinist vise assembly with control over the clamping or closing force of the machinist vise upon the workpiece, also a handle that is readily removably mounted to the vice shaft that is sized small enough to provide uninterrupted continuous rotation of the vice shaft to support rapid opening and closing of the machinist vise assembly. In addition, the handle should provide for a way to facilitate simple and easily control of the rotational torque applied to the vise shaft thus limiting the clamping or closing force of the vise jaws upon the workpiece, without the need of special torque wrenches or adapters that need to be attached and unattached to the vise shaft resulting in extra time consumed. One of the most consistent ways to control the rotational torque applied to a shaft without the cumbersome use of a separate torque wrench, is to have the user grasp the periphery of a disc in their hand that is rotationally engaged to the vice shaft, to rotate the vise shaft thus giving the user a true “feel” for the rotational torque applied to the vise shaft to enable a degree of consistency between different users who have typically have very similar finger and hand strengths so that the rotational tightening torque on the vise shaft would be based upon the frictional grip of the user's hand on the disk periphery resulting from the coefficient of friction between the user's hand and the disk periphery. In summary, an improved manual handle apparatus would result in reducing the time it takes to set the machinist vice jaws to accept the workpiece and to properly clamp the work piece in the vise jaws with the correct amount clamping force and repeating this operation for subsequent workpieces with minimal complexity while only requiring a single hand of the user for optimum efficiency and minimum time consumed.

### SUMMARY OF INVENTION

The present invention is a manual handle apparatus for use in selectively setting at least one of a plurality of vise jaws to clamp and unclamp a workpiece in a vise having a base utilizing a vise shaft that converts rotational motion into relative axial movement of at least one of the plurality of vise jaws. The manual handle apparatus includes a disc having a disc face and a disc annular surface, the disc having a disc axial axis that is substantially perpendicular to the disc face, the disc axial axis being positioned in a central portion of the disc. The disc also includes an aperture therethrough positioned coincident with the disc axial axis, with the aperture being sized and configured to rotatably drive the vise shaft. The disc also has an outer periphery with a corrugated surface that is adapted to provide a handgrip for a user, with the disc periphery not extending beyond the vise base. Also included is a hub having a proximal end portion and a distal end portion, the hub having a hub axial axis extending between the proximal end portion and the distal end portion. The hub proximal end portion is adjacent to the disc annular surface with the hub axial axis positioned coaxial to the disc axial axis with the hub forming an extension from the disc annular surface. The hub also includes an aperture therethrough that is aligned with the disc aperture therethrough, the hub distal end portion is positioned to face the vise, the hub also has an outer surface not extending to the disc outer periphery between the hub proximal end portion and the hub distal end portion such that an annular recess is formed between the disc annular surface and the hub outer surface. Wherein, the annular recess is operational to allow a user's hand to exert axial force on the disc annular surface away from the vise to remove the manual handle apparatus from the shaft. In addition, the corrugated surface that is adapted to provide a hand grip is operational to limit a rotational torque on the vise shaft resulting in a limit on the user's hand to close at least one of the plurality of vise jaws to clamp the workpiece such that an amount of clamping force placed upon the workpiece is limited by a frictional grip of the user's hand on the disc periphery.

These and other objects of the present invention will become more readily appreciated and understood from a consideration of the following detailed description of the exemplary embodiment(s) of the present invention when taken together with the accompanying drawings, in which;

### BRIEF DESCRIPTION OF DRAWINGS

FIG. 1 shows a perspective view of the exemplary embodiment of the manual handle apparatus from the disc face side;

FIG. 2 shows a perspective view of either the exemplary embodiment or alternative embodiment of the manual handle apparatus from the disc annular surface side;

FIG. 3 shows a crossectional view taken from section 3-3 in FIG. 1 of the exemplary embodiment of the manual handle apparatus;

FIG. 4 shows a perspective view of the alternative embodiment of the manual handle apparatus from the solid disc face side;

FIG. 5 shows a crossectional view taken from section 5-5 in FIG. 4 of the alternative embodiment of the manual handle apparatus;

FIG. 6 shows a perspective view of the manual handle apparatus in use as attached to a portion of the vise;

FIG. 7 shows a side elevation view of the manual handle apparatus in use as attached to a portion of the vise; and

FIG. 8 shows a perspective view of the manual handle apparatus in use as attached to the vise including the vise jaws and workpiece.

### REFERENCE NUMBER IN DRAWINGS

20 Manual Handle Apparatus exemplary embodiment
21 Manual Handle Apparatus alternative embodiment
22 Vise jaw
23 Vise base
24 Workpiece
25 Manual handle Apparatus rotation
26 Vise assembly
27 Vise mounting surface
30 Vise shaft
31 Vise closing movement
32 Disc
34 Disc axial axis
36 Disc annular surface
37 Disc face
38 Disc central portion
39 Disc indicia
40 Disc aperture therethrough
44 Disc outer periphery
46 Corrugated surface
50 Hub
52 Hub axial axis
54 Hub proximal end portion
56 Hub distal end portion
60 Hub aperture therethrough
61 Drive face
62 Hub outer surface
64 Annular recess
68 Axial force to close vise jaws
70 Crank
71 Crank rotation
72 Crank fastener of a socket head cap screw
73 Means for axially retaining the manual handle apparatus 20 or 21 to the shaft 30
74 Socket set screw
76 Solid disc
78 Solid disc axial axis
80 Solid disc face
81 Solid disc annular surface
82 Solid disc central portion
84 Solid disc outer periphery
86 Distance between disc outer periphery 44 or 84 and the vise mounting surface 28 when the manual handle apparatus 20 or 21 is in use with the vise 26

### DETAILED DESCRIPTION

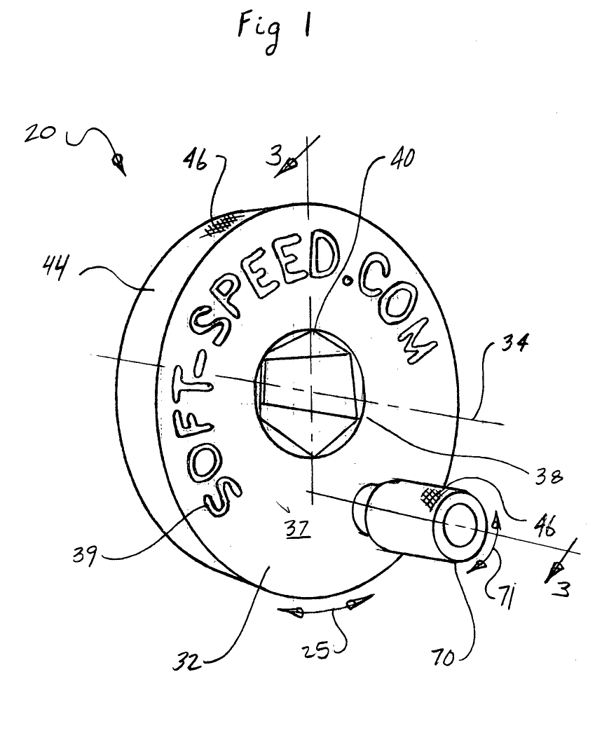

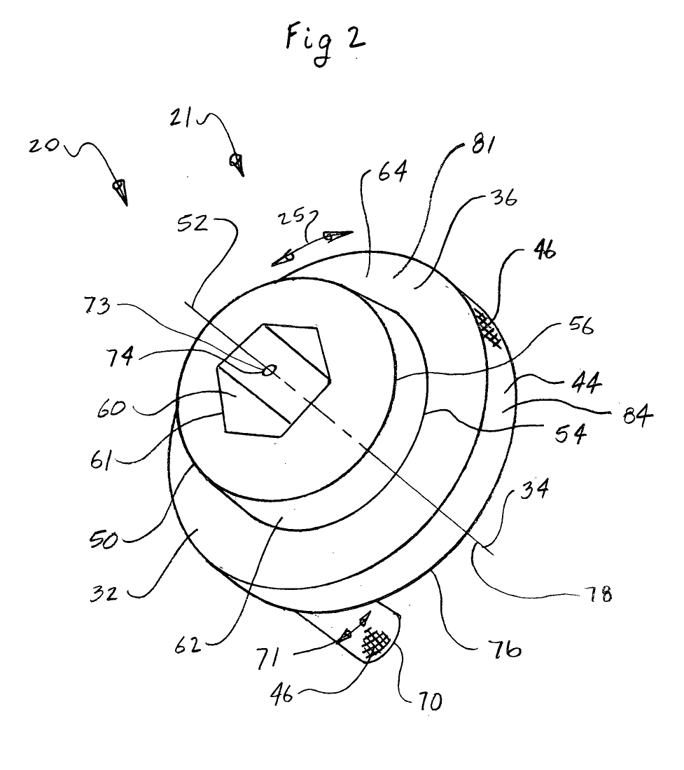

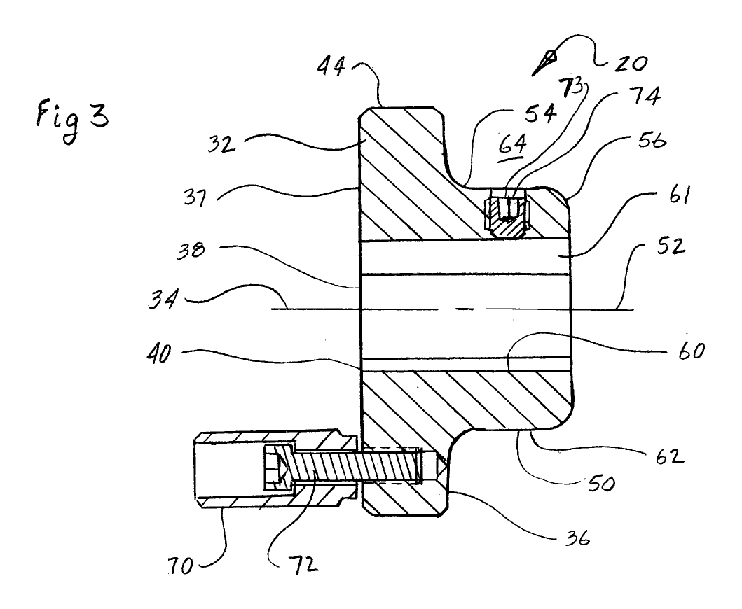

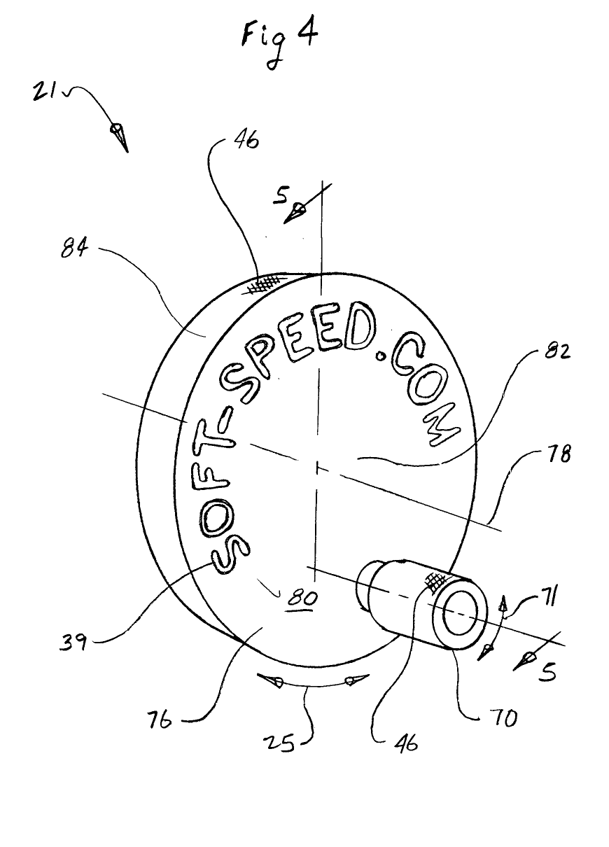

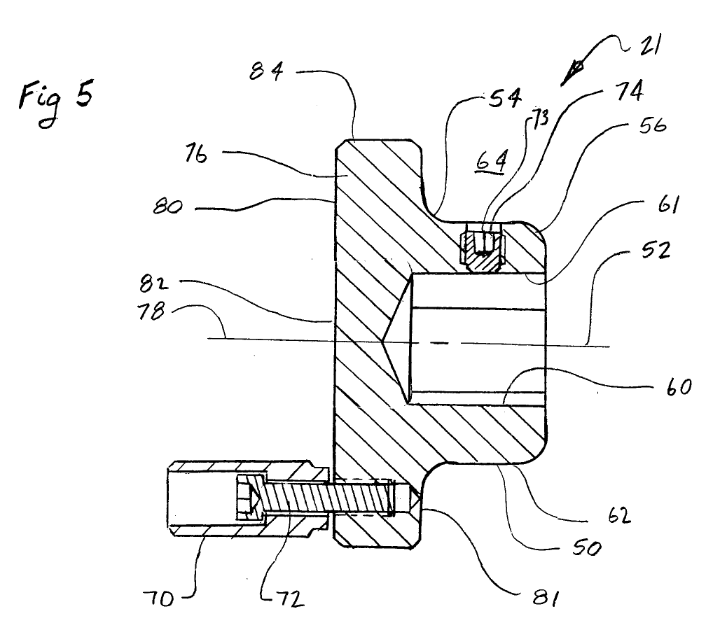

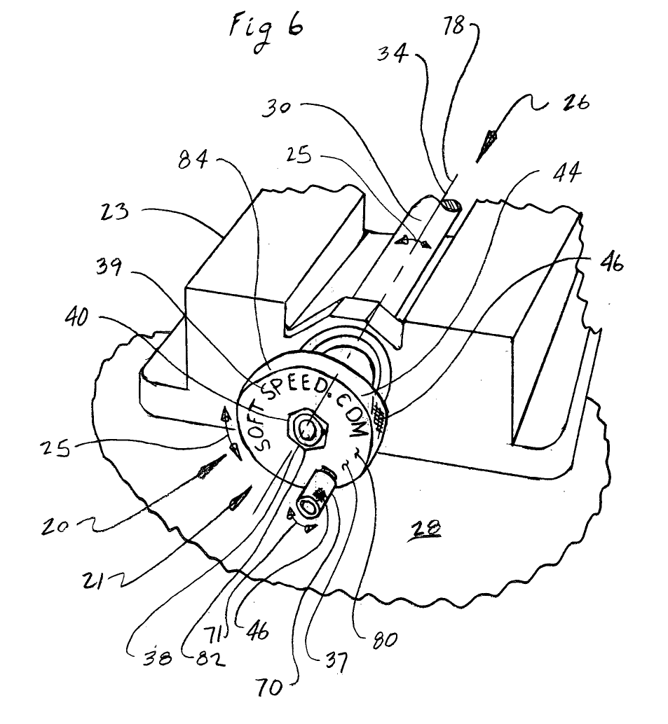

With initial reference to FIGS. 1 through 5 being for the structural detail of the present invention and FIGS. 6 through 8 being for the use of the present invention in conjunction with a machinists vise, the following description starts with the structural detail on the present invention. FIG. 1 shows a perspective view of the exemplary embodiment of the manual handle apparatus 20 from the disc face side 37, and FIG. 2 shows a perspective view of either the exemplary embodiment 20 or an alternative embodiment 21 of the manual handle apparatus from the disc annular surface side 36 or the solid disc annular surface side 81. Further, FIG. 3 shows a crossectional view taken from section 3-3 in FIG. 1 of the exemplary embodiment 20 of the manual handle apparatus, FIG. 4 shows a perspective view of the alternative embodiment 21 of the manual handle apparatus from the solid disc face side 80, and FIG. 5 shows a crossectional view taken from section 5-5 in FIG. 4 of the alternative embodiment 21 of the manual handle apparatus.

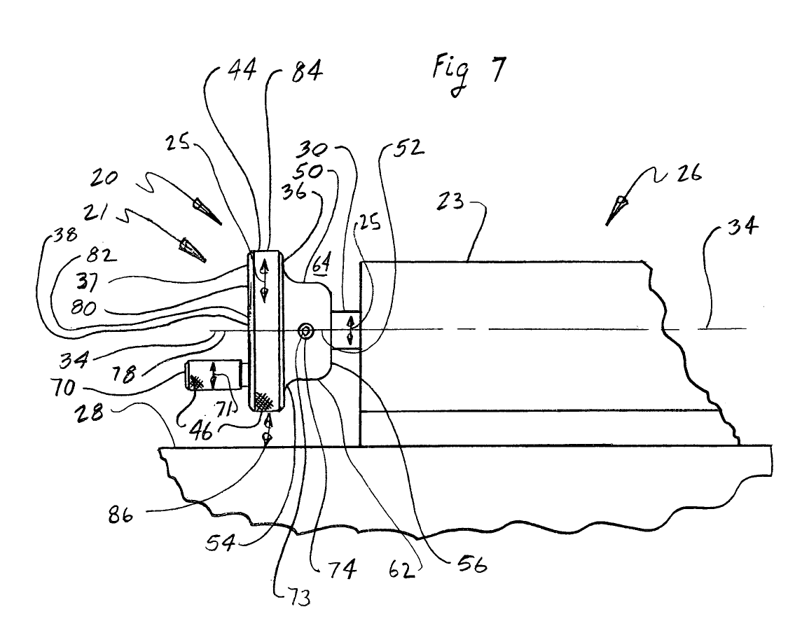

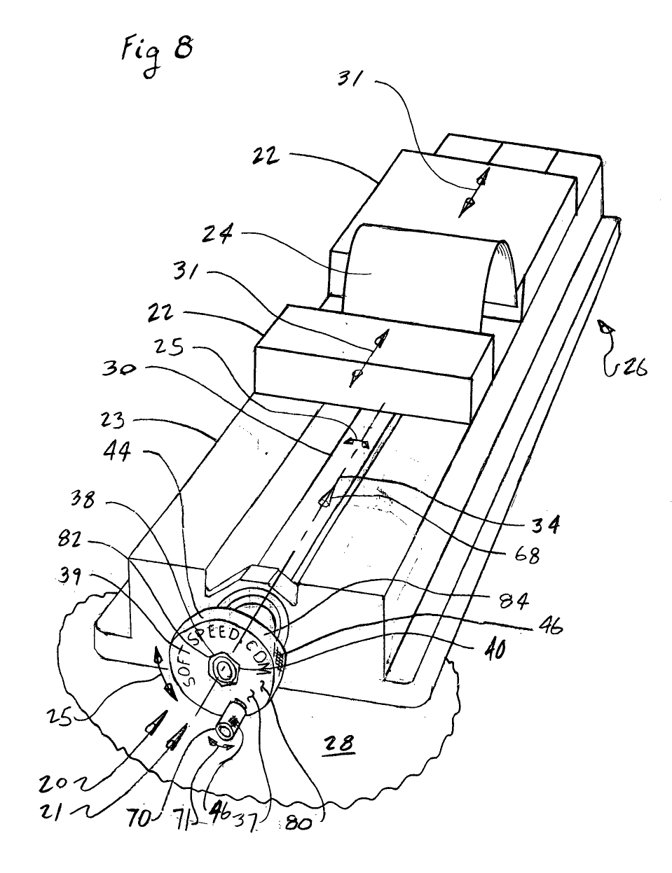

Starting with the exemplary embodiment 20 of the manual handle apparatus for use in selectively setting or positioning the distance between at least one of a plurality of vise jaws 22 (as best shown in FIG. 8) to clamp and unclamp a workpiece 24 in a vise assembly 26 having a base 23 utilizing a vise shaft 30 that converts rotational motion 25 into relative axial movement or vise closing or opening movement 31 of at least one of the plurality of vise jaws 22. The exemplary embodiment 20 of the manual handle apparatus includes a disc 32, having a disc face 37, and a disc annular surface 36. The disc 32 also has a disc axial axis 34 that is substantially perpendicular to the disc face 37, with the disc axial axis 34 being positioned in a central portion 38 of the disc. The disc 32 also includes an aperture therethrough 40 positioned coincident with the disc axial axis 34. The disc aperture 40 is sized and configured to rotatably 25 drive the vise shaft 30 (as best shown in FIGS. 6, 7, and 8), with the disc 32 also having an outer periphery 44 with a corrugated surface 46 that is adapted to provide a hand grip for a user. In addition, looking specifically to FIG. 7 the disc outer periphery 44 does not extend beyond the vise base 28, thus forming a dimensional gap or distance 86 between the disc outer periphery 44 and the vise mounting surface 28 when the manual handle apparatus 20 is in use with the vise 26. This allows the exemplary embodiment 20 of the manual handle apparatus to not be in the way of the vise assembly 26 or vise mounting surface 28 during machining operations, thus accommodating the previously mentioned low profile of a machinists vise 26.

Continuing with the exemplary embodiment 20 of the manual handle apparatus also included is a hub 50 having a proximal end portion 54 and a distal end portion 56, with the hub 50 also having a hub axial axis 52 extending between the proximal end portion 54 and the distal end portion 56. The hub proximal end portion 54 is adjacent to the disc annular surface 36 with the hub axial axis 52 positioned coaxial to the disc axial axis 34 with the hub 50 essentially forming an extension from the disc annular surface 36. The hub 50 also includes an aperture therethrough 60 that is aligned with the disc aperture therethrough 40. The hub distal end portion 56 is positioned to face the vise assembly 26 (as best shown in Figure 7). The hub 50 also has an outer surface 62 that does not extend to the disc outer periphery 44 between the hub proximal end portion 54 and the hub distal end portion 56, such that an annular recess 64 is formed between the disc annular surface 36 and the hub outer surface 62. The aforementioned annular recess 64 is operational to allow a user's hand to exert axial force along the disc axial axis 34 on the disc annular surface 36 away from the vise assembly 26 to remove the exemplary embodiment 20 of the manual handle apparatus from the shaft 30. The corrugated surface 46 that is adapted to provide a hand grip is operational to limit a rotational 25 torque on the vise shaft 30 resulting in a limit on the user's hand to close at least one of the plurality of vise jaws 22 (as best shown in FIG. 8) to clamp the workpiece 24 such that an amount of clamping or axial force 68 placed upon the workpiece 24 is limited by a frictional grip of the user's hand on the disc periphery 44. The corrugations 46 on the disc periphery 44 can be varied in size to indirectly control the rotational 25 torque that the user's hand can impart to the disc periphery 44 thus resulting in controlling or limiting on the user's hand to close at least one of the plurality of vise jaws 22 (as best shown in FIG. 8) to clamp the workpiece 24 such that an desired or selected amount of clamping or axial force 68 is placed upon the workpiece 24, being especially important if the workpiece 24 is thin, delicate, small, and the like. Preferably the corrugations 46 are a medium diamond knurl, however, more course knurls or more fine knurls could be utilized to either further increase the workpiece 24 clamping force 68 or further decrease the workpiece 24 clamping force 68.

The apertures therethrough for both the disc aperture therethrough 40 and the hub aperture therethrough 60 are preferably accomplished by the machining of a 3/4 inch hex having a plurality of drive faces 61 through each the disc aperture 40 and the hub aperture 60 to slidably engage and rotatably 25 drive the vise shaft 30. Alternatively, other ways of accomplishing the disc aperture 40 and the hub aperture 60 to slidably engage and rotatably 25 drive the vise shaft 30 can be utilized such as a single flat or a plurality of flats, such as a square drive that are axially oriented along the disc axial axis 34 and the hub axial axis 52, or a conventional key and slot arrangement, threads, elliptical, semi circular, or other types of drives known in the art that meet the above requirements. Note, that it is acceptable for either of the disc aperture 40 or the hub aperture 60 to slidably engage and rotatably drive the vise shaft 30, in other words the exemplary embodiment 20 of the manual handle apparatus will function adequately if only the disc aperture 40 or the hub aperture 60 rotatably 25 drive the vise shaft 30, however, if the disc aperture 40 rotatably 25 drives the vise shaft 30, then the hub aperture 60 must freely slide over the vise shaft 30 and vice versa, wherein if the hub aperture 60 rotatably 25 drives the vise shaft 30, then the disc aperture 40 must freely slide over the vise shaft 30.

The benefit of the corrugations 46 over a conventional vise handle that has a perpendicular extension to the vise shaft are that the control of the rotational 25 torque applied to the vise shaft 30 without the cumbersome use of a separate torque wrench, is to have the user grasp the periphery 44 of the disc 32 in their hand, wherein the disc 32 is rotationally 25 engaged to the vise shaft 30, to rotate 25 the vise shaft 30 thus giving the user a true “feel” for the rotational 25 torque applied to the vise shaft 30. This enables a degree of consistency between different users that typically have very similar finger and hand strengths so that the rotational 25 tightening torque on the vise shaft 30 would be based upon the frictional grip of the user's hand on the disc periphery 44 based on the coefficient of friction between the user's hand and the disk periphery 44 which is indirectly controlled by the corrugations 46 size as previously described. This is as compared to a conventional vise handle wherein a user applies force to a handle extension to create rotational torque on the vise shaft, with substantial variability between users of the amount of force placed upon the handle extension, based on arm strength and weight which results in variable clamping forces on the workpiece.

As the disc 32 and the hub 50 are adjacent to each other as described above, optionally the disc 32 and the hub 50 can be affixed to one another, either by welding, attachment through fasteners, shrink fit, press fit, or the like would be acceptable, also optionally the disc 32 and the hub 50 can be integral to one another constructed of homogeneous material. Also, alternatively, the disc 32 and the hub 50 can be detachable from one another by the use of a threaded portion between the disc 32 and the hub 50 or a twisting interlock, retaining grooves and protrusions, and the like. The materials of construction of both the disc 32 and the hub 50 are preferably aluminum, specifically Grade 6061-T65, however, a number of other materials would be acceptable such as stainless steels, carbon steels, or any number of plastics or composites as long as the functional requirements as described are complied with. Optionally, on the materials of construction, specifically for the aluminum, outer surface wear and/or corrosion protection is can be added such as blue or other color hard anodizing or other surface treatments for surface wear and/or corrosion protection in various colors that are appropriate in the art for other materials of construction such as, stainless steels, carbon steels, or any number of plastics or composites.

Also optionally, a means 73 for axially retaining the exemplary embodiment 20 of the manual handle apparatus to the shaft 30 can be accomplished by the use of a setscrew 74 positioned radially within the hub 50 as shown in FIG. 2 and more specifically in FIG. 3. The set screw 74 is preferably utilizes a 1/4 inch by 20 threads per inch unified national course thread that is located at a midpoint on the hub 50 on the outer surface 62 between the proximal end portion 54 and a distal end portion 56 facing radially inward toward the hub axial axis 52. The set screw 74 itself uses an Allen head adjacent to the hub outer surface 62 and when tightened contacts the vise shaft 30 to axially retain the exemplary embodiment 20 of the manual handle apparatus to the shaft 30. Other devices for accomplishing the aforementioned means 73 would be acceptable also such as pins, adhesive, keys, threads, retaining rings, and the like as are known in the art.

Another option for the exemplary embodiment 20 of the manual handle apparatus, referring specifically to FIG. 3, is the addition of a crank 70 that is rotatably 71 engaged to the disc face 37, wherein the crank 70 is operational in the user's hand to quickly rotate 25 the disc 32 and hence the exemplary embodiment 20 of the manual handle apparatus for the purpose to quickly open or optionally close at least one of the plurality of vise jaws 22 to position the vise jaws to accept the workpiece 24 as best shown in FIG. 8. The crank 70 as specifically shown in FIG. 3 is rotatably 71 engaged to the disc face 37 by the use of a socket head cap screw 72 that is threaded into the disc 32 on the disc face 37 side with a size number 10 by 32 threads per inch thread at a depth of 0.45 inches. Thus, when the screw 72 is threaded into the disc 32, the screw 72 will bottom out prior to axially clamping the crank 70 and with the crank 70 being rotationally 71 slidable on the screw 72, the crank 70 is rotatably 71 engaged to the disc face 37. Other types of ways for the crank 70 to be rotatably 71 engaged to the disc face 37 are acceptable such as retainer rings, slip joints, and the like could be utilized. The crank can also have corrugations 46 to aid in the user's hand gripping the crank 70 for the purpose of quickly opening or optionally closing at least one of the plurality of vise jaws 22 to position the vise jaws to accept the workpiece 24 as best again shown in FIG. 8.

A further option for the exemplary embodiment 20 of the manual handle apparatus is to have indicia 39 visibly disposed or superimposed on the disc face 37 for the purpose of operating instructions for the use of the exemplary embodiment 20 of the manual handle apparatus or a promotional message and the like. The indicia 39 can be engraved on the disc face 37 or be painted, decaled, etched, and so on. Preferably, the vise assembly 26 is a 6 inch machinists vise such as a KURT, CHICK, PARLEC, or IMPORT that typically use a 3/4 inch hex vise shaft 30 rotational drive. However, other vises could use the exemplary embodiment 20 of the manual handle apparatus as the size and rotational drive interface of the present invention could be altered to accommodate other types and sizes of vises.

Moving next, to the alternative embodiment 21 of the manual handle apparatus, specifically referring to FIGS. 4 and 5, and to FIG. 2 which is applicable to both the exemplary embodiment 20 and the alternative embodiment 21 of the manual handle apparatus. The alternative embodiment 21 of the manual handle apparatus for use in selectively setting or positioning the distance between at least one of a plurality of vise jaws 22 (as best shown in FIG. 8) to clamp and unclamp a workpiece 24 in a vise assembly 26 having a base 23 utilizing a vise shaft 30 that converts rotational motion 25 into relative axial movement or vise closing or opening movement 31 of at least one of the plurality of vise jaws 22. The alternative embodiment 21 of the manual handle apparatus includes a solid disc 76, having a disc face 80, and a disc annular surface 81. The disc 76 also has a disc axial axis 78 that is substantially perpendicular to the disc face 80, with the disc axial axis 78 being positioned in a central portion 82 of the disc. The disc 76 also having an outer periphery 84 with a corrugated surface 46 that is adapted to provide a handgrip for a user. In addition, looking specifically to FIG. 7 the disc outer periphery 84 does not extend beyond the vise base 28, thus forming a dimensional gap or distance 86 between the disc outer periphery 84 and the vise mounting surface 28 when the manual handle apparatus 21 is in use with the vise 26. This allows the alternative embodiment 21 of the manual handle apparatus to not be in the way of the vise assembly 26 or vise mounting surface 28 during machining operations, thus accommodating the previously mentioned low profile of a machinists vise 26.

Continuing with the alternative embodiment 21 of the manual handle apparatus also included is a hub 50 having a proximal end portion 54 and a distal end portion 56, with the hub 50 also having a hub axial axis 52 extending between the proximal end portion 54 and the distal end portion 56. The hub proximal end portion 54 is adjacent to the disc annular surface 81 with the hub axial axis 52 positioned coaxial to the disc axial axis 78 with the hub 50 essentially forming an extension from the disc annular surface 81. The hub 50 also includes an aperture therethrough 60 that is sized and configured to rotatably 25 drive the vise shaft 30. The hub distal end portion 56 is positioned to face the vise assembly 26 (as best shown in FIG. 7). The hub 50 also has an outer surface 62 that does not extend to the disc outer periphery 84 between the hub proximal end portion 54 and the hub distal end portion 56, such that an annular recess 64 is formed between the disc annular surface 81 and the hub outer surface 62. The aforementioned annular recess 64 is operational to allow a user's hand to exert axial force along the disc axial axis 78 on the disc annular surface 81 away from the vise assembly 26 to remove the alternative embodiment 21 of the manual handle apparatus from the shaft 30. The corrugated surface 46 that is adapted to provide a hand grip is operational to limit a rotational 25 torque on the vise shaft 30 resulting in a limit on the user's hand to close at least one of the plurality of vise jaws 22 (as best shown in FIG. 8) to clamp the workpiece 24 such that an amount of clamping or axial force 68 placed upon the workpiece 24 is limited by a frictional grip of the user's hand on the disc periphery 84. The corrugations 46 on the disc periphery 84 can be varied in size to indirectly control the rotational 25 torque that the user's hand can impart to the disc periphery 84 thus resulting in controlling or limiting on the user's hand to close at least one of the plurality of vise jaws 22 (as best shown in FIG. 8) to clamp the workpiece 24 such that an desired or selected amount of clamping or axial force 68 is placed upon the workpiece 24, being especially important if the workpiece 24 is thin, delicate, small, and the like. Preferably the corrugations 46 are a medium diamond knurl, however, more course knurls or more fine knurls could be utilized to either further increase the workpiece 24 clamping force 68 or further decrease the workpiece 24 clamping force 68.

The hub aperture therethrough 60 is preferably accomplished by the machining of a 3/4 inch hex having a plurality of drive faces 61 through the hub aperture 60 to slidably engage and rotatably 25 drive the vise shaft 30. Alternatively, other ways of accomplishing the hub aperture 60 to slidably engage and rotatably 25 drive the vise shaft 30 can be utilized such as a single flat or a plurality of flats, such as a square drive that are axially oriented along the hub axial axis 52, or a conventional key and slot arrangement, threads, elliptical, semi circular, or other types of drives known in the art that meet the above requirements.

The benefit of the corrugations 46 over a conventional vise handle that has a perpendicular extension to the vise shaft are that the control of the rotational 25 torque applied to the vise shaft 30 without the cumbersome use of a separate torque wrench, is to have the user grasp the periphery 84 of the disc 76 in their hand, wherein the disc 76 is rotationally 25 engaged to the vise shaft 30, to rotate 25 the vise shaft 30 thus giving the user a true “feel” for the rotational 25 torque applied to the vise shaft 30. This enables a degree of consistency between different users that typically have very similar finger and hand strengths so that the rotational 25 tightening torque on the vise shaft 30 would be based upon the frictional grip of the user's hand on the disc periphery 84 based on the coefficient of friction between the user's hand and the disk periphery 84 which is indirectly controlled by the corrugations 46 size as previously described. This is as compared to a conventional vise handle wherein a user applies force to a handle extension to create rotational torque on the vise shaft, with substantial variability between users of the amount of force placed upon the handle extension, based on arm strength and weight which results in variable clamping forces on the workpiece.

As the disc 76 and the hub 50 are adjacent to each other as described above, optionally the disc 76 and the hub 50 can be affixed to one another, either by welding, attachment through fasteners, shrink fit, press fit, or the like would be acceptable, also optionally the disc 76 and the hub 50 can be integral to one another constructed of homogeneous material. Also, alternatively, the disc 76 and the hub 50 can be detachable from one another by the use of a threaded portion between the disc 76 and the hub 50 or a twisting interlock, retaining grooves and protrusions, and the like. The materials of construction of both the disc 76 and the hub 50 are preferably aluminum, specifically Grade 6061-T65, however, a number of other materials would be acceptable such as stainless steels, carbon steels, or any number of plastics or composites as long as the functional requirements as described are complied with. Optionally, on the materials of construction, specifically for the aluminum, outer surface wear and/or corrosion protection is can be added such as blue or other color hard anodizing or other surface treatments for surface wear and/or corrosion protection in various colors that are appropriate in the art for other materials of construction such as, stainless steels, carbon steels, or any number of plastics or composites.

Also optionally, a means 73 for axially retaining the alternative embodiment 21 of the manual handle apparatus to the shaft 30 can be accomplished by the use of a setscrew 74 positioned radially within the hub 50 as shown in Figure 2 and more specifically in FIG. 5. The set screw 74 preferably utilizes a 1/4 inch by 20 threads per inch unified national course thread that is located at a midpoint on the hub 50 on the outer surface 62 between the proximal end portion 54 and a distal end portion 56 facing radially inward toward the hub axial axis 52. The set screw 74 itself uses an Allen head adjacent to the hub outer surface 62 and when tightened contacts the vise shaft 30 to axially retain the alternative embodiment 21 of the manual handle apparatus to the shaft 30. Other devices for accomplishing the aforementioned means 73 would be acceptable also such as pins, adhesive, keys, threads, retaining rings, and the like as are known in the art.

Another option for the alternative embodiment 21 of the manual handle apparatus, referring specifically to FIG. 5, is the addition of a crank 70 that is rotatably 71 engaged to the disc face 80, wherein the crank 70 is operational in the user's hand to quickly rotate 25 the disc 76 and hence the alternative embodiment 21 of the manual handle apparatus for the purpose to quickly open or optionally close at least one of the plurality of vise jaws 22 to position the vise jaws to accept the workpiece 24 as best shown in FIG. 8. The crank as 70 specifically shown in FIG. 5 is rotatably 71 engaged to the disc face 80 by the use of a socket head cap screw 72 that is threaded into the disc 76 on the disc face 80 side with a size number 10 by 32 threads per inch thread at a depth of 0.45 inches. Thus, when the screw 72 is threaded into the disc 76, the screw 72 will bottom out prior to axially clamping the crank 70 and with the crank 70 being rotationally 71 slidable on the screw 72, the crank 70 is rotatably 71 engaged to the disc face 80. Other types of ways for the crank 70 to be rotatably 71 engaged to the disc face 80 are acceptable such as retainer rings, slip joints, and the like could be utilized. The crank can also have corrugations 46 to aid in the user's hand gripping the crank 70 for the purpose of quickly opening or optionally closing at least one of the plurality of vise jaws 22 to position the vise jaws to accept the workpiece 24 as best again shown in FIG. 8.

A further option for the alternative embodiment 21 of the manual handle apparatus is to have indicia 39 visibly disposed or superimposed on the disc face 80 for the purpose of operating instructions for the use of the alternative embodiment 21 of the manual handle apparatus or a promotional message and the like. The indicia 39 can be engraved on the disc face 80 or be painted, decaled, etched, and so on. Preferably, the vise assembly 26 is a 6 inch machinists vise such as a KURT, CHICK, PARLEC, or IMPORT that typically use a 3/4 inch hex vise shaft 30 rotational drive. However, other vises could use the alternative embodiment 21 of the manual handle apparatus as the size and rotational drive interface of the present invention could be altered to accommodate other types and sizes of vises.

Method of Use

Referring specifically to FIGS. 6 through 8 for the use of the present invention in conjunction with a machinists vise; FIG. 6 shows a perspective view of either the exemplary embodiment 20 or the alternative embodiment 21 of the manual handle apparatus in use as attached to a portion of the vise assembly 26, FIG. 7 shows a side elevation view of either the exemplary embodiment 20 or the alternative embodiment 21 the manual handle apparatus in use as attached to a portion of the vise assembly 26, and FIG. 8 shows a perspective view of either the exemplary embodiment 20 or the alternative embodiment 21 the manual handle apparatus in use as attached to the vise shaft 30, including the vise jaws 22 and workpiece 24.

Starting with the step of providing with the exemplary embodiment 20 of the manual handle apparatus for use in selectively setting or positioning the distance between at least one of a plurality of vise jaws 22 (as best shown in FIG. 8) to clamp and unclamp a workpiece 24 in a vise assembly 26 having a base 23 utilizing a vise shaft 30 that converts rotational motion 25 into relative axial movement or vise closing or opening movement 31 of at least one of the plurality of vise jaws 22. The exemplary embodiment 20 of the manual handle apparatus includes a disc 32, having a disc face 37, and a disc annular surface 36. The disc 32 also has a disc axial axis 34 that is substantially perpendicular to the disc face 37, with the disc axial axis 34 being positioned in a central portion 38 of the disc. The disc 32 also includes an aperture therethrough 40 positioned coincident with the disc axial axis 34. The disc aperture 40 is sized and configured to rotatably 25 drive the vise shaft 30 (as best shown in Figures 6, 7, and 8), with the disc 32 also having an outer periphery 44 with a corrugated surface 46 that is adapted to provide a hand grip for a user. In addition, looking specifically to FIG. 7 the disc outer periphery 44 does not extend beyond the vise base 28, thus forming a dimensional gap or distance 86 between the disc outer periphery 44 and the vise mounting surface 28 when the manual handle apparatus 20 is in use with the vise 26. This allows the exemplary embodiment 20 of the manual handle apparatus to not be in the way of the vise assembly 26 or vise mounting surface 28 during machining operations, thus accommodating the previously mentioned low profile of a machinists vise 26.

Continuing with the step of providing of the exemplary embodiment 20 of the manual handle apparatus also included is a hub 50 having a proximal end portion 54 and a distal end portion 56, with the hub 50 also having a hub axial axis 52 extending between the proximal end portion 54 and the distal end portion 56. The hub proximal end portion 54 is adjacent to the disc annular surface 36 with the hub axial axis 52 positioned coaxial to the disc axial axis 34 with the hub 50 essentially forming an extension from the disc annular surface 36. The hub 50 also includes an aperture therethrough 60 that is aligned with the disc aperture therethrough 40. The hub distal end portion 56 is positioned to face the vise assembly 26 (as best shown in FIG. 7). The hub 50 also has an outer surface 62 that does not extend to the disc outer periphery 44 between the hub proximal end portion 54 and the hub distal end portion 56, such that an annular recess 64 is formed between the disc annular surface 36 and the hub outer surface 62. The aforementioned annular recess 64 is operational to allow a user's hand to exert axial force along the disc axial axis 34 on the disc annular surface 36 away from the vise assembly 26 to remove the exemplary embodiment 20 of the manual handle apparatus from the shaft 30. The corrugated surface 46 that is adapted to provide a hand grip is operational to limit a rotational 25 torque on the vise shaft 30 resulting in a limit on the user's hand to close at least one of the plurality of vise jaws 22 (as best shown in FIG. 8) to clamp the workpiece 24 such that an amount of clamping or axial force 68 placed upon the workpiece 24 is limited by a frictional grip of the user's hand on the disc periphery 44. The corrugations 46 on the disc periphery 44 can be varied in size to indirectly control the rotational 25 torque that the user's hand can impart to the disc periphery 44 thus resulting in controlling or limiting on the user's hand to close at least one of the plurality of vise jaws 22 (as best shown in FIG. 8) to clamp the workpiece 24 such that an desired or selected amount of clamping or axial force 68 is placed upon the workpiece 24, being especially important if the workpiece 24 is thin, delicate, small, and the like. Preferably the corrugations 46 are a medium diamond knurl, however, more course knurls or more fine knurls could be utilized to either further increase the workpiece 24 clamping force 68 or further decrease the workpiece 24 clamping force 68.

A further step is to engage in grasping the disc 32 outer periphery 44 in the user's hand, either between the thumb and forefingers or in using the palm of the user's hand, a next step is in aligning the hub aperture 60 of the hub distal end portion 56 to the vise shaft 30 and axially sliding the hub aperture 60 onto the vise shaft 30 and continuing to slide the shaft 30 through the disc aperture 40 until the shaft 30 is flush with or extends beyond said disc face 37. A next further step is spinning rotationally 25 the disc outer periphery 44 by grasping in the user's hand, either between the thumb and forefingers or in using the palm of the user's hand the disc outer periphery 44 to open or close at least one of the plurality of vise jaws 22 to position the vise jaws 22 to accept the workpiece 24. Yet, a further step is rotating 25 the disc outer periphery 44 by grasping in the user's hand, either between the thumb and forefingers or in using the palm of the user's hand the disc outer periphery 44 to close at least one of the plurality of vise jaws 22 to clamp the workpiece 24 such that an amount of clamping force 68 placed upon the workpiece 24 is limited by a frictional grip of the user's hand on said disc periphery 44.

Optionally, the step of providing the exemplary embodiment 20 of the manual handle apparatus further includes a means 73 for axially retaining the exemplary embodiment 20 of the manual handle apparatus to the shaft 30 and an additional step after the aligning step further comprising engaging the means 73 between the exemplary embodiment 20 of the manual handle apparatus and the shaft 30 being operational to retain the exemplary embodiment 20 of the manual handle apparatus on the shaft 30. Also, optionally, the step of providing the exemplary embodiment 20 manual handle apparatus further includes a crank 70 rotatably 71 engaged to the disc face 37 and wherein the step of spinning rotationally 25 is accomplished by grasping in the user's hand, either between the thumb and forefingers or in using the palm of the user's hand the crank 70 being operational to quickly rotate 25 the disc 32 and open or close at least one of the plurality of vise jaws 22 to position the vise jaws 22 to accept the workpiece 24.

Moving next, to the step of providing the alternative embodiment 21 of the manual handle apparatus, specifically referring to FIGS. 4 and 5, and to FIG. 2 which is applicable to both the exemplary embodiment 20 and the alternative embodiment 21 of the manual handle apparatus. The alternative embodiment 21 of the manual handle apparatus for use in selectively setting or positioning the distance between at least one of a plurality of vise jaws 22 (as best shown in FIG. 8) to clamp and unclamp a workpiece 24 in a vise assembly 26 having a base 23 utilizing a vise shaft 30 that converts rotational motion 25 into relative axial movement or vise closing or opening movement 31 of at least one of the plurality of vise jaws 22. The alternative embodiment 21 of the manual handle apparatus includes a solid disc 76, having a disc face 80, and a disc annular surface 81. The disc 76 also has a disc axial axis 78 that is substantially perpendicular to the disc face 80, with the disc axial axis 78 being positioned in a central portion 82 of the disc. The disc 76 also having an outer periphery 84 with a corrugated surface 46 that is adapted to provide a handgrip for a user. In addition, looking specifically to FIG. 7 the disc outer periphery 84 does not extend beyond the vise base 28, thus forming a dimensional gap or distance 86 between the disc outer periphery 84 and the vise mounting surface 28 when the manual handle apparatus 21 is in use with the vise 26. This allows the alternative embodiment 21 of the manual handle apparatus to not be in the way of the vise assembly 26 or vise mounting surface 28 during machining operations, thus accommodating the previously mentioned low profile of a machinists vise 26.

Continuing with the step of providing the alternative embodiment 21 of the manual handle apparatus also included is a hub 50 having a proximal end portion 54 and a distal end portion 56, with the hub 50 also having a hub axial axis 52 extending between the proximal end portion 54 and the distal end portion 56. The hub proximal end portion 54 is adjacent to the disc annular surface 81 with the hub axial axis 52 positioned coaxial to the disc axial axis 78 with the hub 50 essentially forming an extension from the disc annular surface 81. The hub 50 also includes an aperture therethrough 60 that is sized and configured to rotatably 25 drive the vise shaft 30. The hub distal end portion 56 is positioned to face the vise assembly 26 (as best shown in FIG. 7). The hub 50 also has an outer surface 62 that does not extend to the disc outer periphery 84 between the hub proximal end portion 54 and the hub distal end portion 56, such that an annular recess 64 is formed between the disc annular surface 81 and the hub outer surface 62. The aforementioned annular recess 64 is operational to allow a user's hand to exert axial force along the disc axial axis 78 on the disc annular surface 81 away from the vise assembly 26 to remove the alternative embodiment 21 of the manual handle apparatus from the shaft 30. The corrugated surface 46 that is adapted to provide a hand grip is operational to limit a rotational 25 torque on the vise shaft 30 resulting in a limit on the user's hand to close at least one of the plurality of vise jaws 22 (as best shown in FIG. 8) to clamp the workpiece 24 such that an amount of clamping or axial force 68 placed upon the workpiece 24 is limited by a frictional grip of the user's hand on the disc periphery 84. The corrugations 46 on the disc periphery 84 can be varied in size to indirectly control the rotational 25 torque that the user's hand can impart to the disc periphery 84 thus resulting in controlling or limiting on the user's hand to close at least one of the plurality of vise jaws 22 (as best shown in FIG. 8) to clamp the workpiece 24 such that an desired or selected amount of clamping or axial force 68 is placed upon the workpiece 24, being especially important if the workpiece 24 is thin, delicate, small, and the like. Preferably the corrugations 46 are a medium diamond knurl, however, more course knurls or more fine knurls could be utilized to either further increase the workpiece 24 clamping force 68 or further decrease the workpiece 24 clamping force 68.

A next step is in grasping the disc outer periphery 84 in the user's hand either between the thumb and forefingers or in using the palm of the user's hand, with a further step of aligning the hub aperture 60 of the hub distal end portion 56 to the vise shaft 30 and axially sliding the hub aperture 60 onto the vise shaft 30 and continuing to slide the shaft 30 through the hub aperture 60 until the shaft contacts the disc 76. Yet, a further step is in spinning the disc outer periphery 84 by grasping the disc outer periphery 84 in the user's hand either between the thumb and forefingers or in using the palm of the user's hand to open or close at least one of the plurality of vise jaws 22 to position the vise jaws 22 to accept the workpiece 24. Yet, a next further step is rotating 25 the disc outer periphery 84 by grasping the disc outer periphery 84 in the user's hand either between the thumb and forefingers or in using the palm of the user's hand to close at least one of the plurality of vise jaws 22 to clamp the workpiece 24 such that an amount of clamping force 68 placed upon the workpiece 24 is limited by a frictional grip of the user's hand on the disc periphery 84.

Optionally, the step of providing the alternative embodiment 21 of the manual handle apparatus further includes a means 73 for axially retaining the alternative embodiment 21 of the manual handle apparatus to the shaft 30 and an additional step after the aligning step further comprising engaging the means 73 between the alternative embodiment 21 of the manual handle apparatus and the shaft 30 being operational to retain the alternative embodiment 21 of the manual handle apparatus on the shaft 30. Also, optionally, the step of providing the alternative embodiment 21 of the manual handle apparatus further includes a crank 70 rotatably 71 engaged to the disc face 80 and wherein the step of spinning rotationally 25 is accomplished by grasping in the user's hand, either between the thumb and forefingers or in using the palm of the user's hand the crank 70 being operational to quickly rotate 25 the disc 32 and open or close at least one of the plurality of vise jaws 22 to position the vise jaws 22 to accept the workpiece 24.

### CONCLUSION

Accordingly, the present invention of a Manual Handle Apparatus has been described with some degree of particularity directed to the embodiment(s) of the present invention. It should be appreciated, though, that the present invention is defined by the following claims construed in light of the prior art so modifications or changes may be made to the exemplary embodiment(s) of the present invention without departing from the inventive concepts contained therein.

1. A manual handle apparatus for use in selectively setting at least one of a plurality of vise jaws to clamp and unclamp a workpiece in a vise having a base utilizing a vise shaft that converts rotational motion into relative axial movement of at least one of the plurality of vise jaws, comprising:
(a) a disc including a disc face and a disc annular surface, said disc having a disc axial axis substantially perpendicular to said disc face, the disc axial axis being positioned in a central portion of said disc, said disc also includes an aperture therethrough positioned coincident with the disc axial axis, said aperture is sized and configured to rotatably drive the vise shaft, said disc also having an outer periphery with a corrugated surface adapted to provide a hand grip for a user, said periphery not extending beyond the vise base; and
(b) a hub including a proximal end portion and a distal end portion, said hub having a hub axial axis extending between said proximal end portion and said distal end portion, said hub proximal end portion is adjacent to said disc annular surface with the hub axial axis positioned coaxial to the disc axial axis with said hub forming an extension from said disc annular surface, said hub also includes an aperture therethrough aligned with said disc aperture therethrough, said hub distal end portion positioned to face the vise, said hub also having an outer surface not extending to said disc outer periphery between said hub proximal end portion and said hub distal end portion such that an annular recess is formed between said disc annular surface and said hub outer surface, wherein said annular recess is operational to allow a user's hand to exert axial force on said disc annular surface away from the vise to remove said manual handle apparatus from the shaft and said corrugated surface that is adapted to provide a hand grip is operational to limit a rotational torque on the vise shaft resulting in a limit on the user's hand to close at least one of the plurality of vise jaws to clamp the workpiece such that an amount of clamping force placed upon the workpiece is limited by a frictional grip of the user's hand on said disc periphery.

2. A manual handle apparatus according to claim 1 wherein said disc and said hub are affixed to one another.

3. A manual handle apparatus according to claim 1 wherein said disc and said hub are integral to one another.

4. A manual handle apparatus according to claim 1 wherein said disc and said hub are detachable from one another.

5. A manual handle apparatus according to claim 1 further comprising a means for axially retaining said manual handle apparatus to the shaft.

6. A manual handle apparatus according to claim 1 further comprising a crank rotatably engaged to said disc face, wherein said crank is operational in the user's hand to quickly rotate said disc and open at least one of the plurality of vise jaws to position the vise jaws to accept the workpiece.

7. A manual handle apparatus according to claim 1 wherein said disc has indicia superimposed on said disc face.

8. A manual handle apparatus for use in selectively setting at least one of a plurality of vise jaws to clamp and unclamp a workpiece in a vise having a base utilizing a vise shaft that converts rotational motion into relative axial movement of at least one of the plurality of vise jaws, comprising:
(a) a disc including a disc face and a disc annular surface, said disc having a disc axial axis substantially perpendicular to said disc face, the disc axial axis being positioned in a central portion of said disc, said disc also having an outer periphery with a corrugated surface adapted to provide a hand grip for a user, said periphery not extending beyond the vise base; and
(b) a hub including a proximal end portion and a distal end portion, said hub having a hub axial axis extending between said proximal end portion and said distal end portion, said hub proximal end portion is adjacent to said disc annular surface with the hub axial axis positioned coaxial to the disc axial axis with said hub forming an extension from said disc annular surface, said hub also includes an aperture therethrough with said hub aperture being sized and configured to rotatably drive the vise shaft, said hub distal end portion positioned to face the vise, said hub also having an outer surface not extending to said disc outer periphery between said hub proximal end portion and said hub distal end portion such that an annular recess is formed between said disc annular surface and said hub outer surface, wherein said annular recess is operational to allow a user's hand to exert axial force on said disc annular surface away from the vise to remove said manual handle apparatus from the shaft and said corrugated surface that is adapted to provide a hand grip is operational to limit a rotational torque on the vise shaft resulting in a limit on the user's hand to close at least one of the plurality of vise jaws to clamp the workpiece such that an amount of clamping force placed upon the workpiece is limited by a frictional grip of the user's hand on said disc periphery.

9. A manual handle apparatus according to claim 8 wherein said disc and said hub are affixed to one another.

10. A manual handle apparatus according to claim 8 wherein said disc and said hub are integral to one another.

11. A manual handle apparatus according to claim 8 wherein said disc and said hub are detachable from one another.

12. A manual handle apparatus according to claim 8 further comprising a means for axially retaining said manual handle apparatus to the shaft.

13. A manual handle apparatus according to claim 8 further comprising a crank rotatably engaged to said disc face, wherein said crank is operational in the user's hand to quickly rotate said disc and open at least one of the plurality of vise jaws to position the vise jaws to accept the workpiece.

14. A manual handle apparatus according to claim 8 wherein said disc has indicia superimposed on said disc face.

15. A method of using a manual handle apparatus for use in selectively setting at least one of a plurality of vise jaws to clamp and unclamp a workpiece in a vise having a base utilizing a vise shaft that converts rotational motion into relative axial movement of at least one of the plurality of vise jaws, comprising the steps of:
(a) providing a manual handle apparatus that includes a disc including a disc face and a disc annular surface, said disc having a disc axial axis substantially perpendicular to said disc face, the disc axial axis being positioned in a central portion of said disc, said disc also includes an aperture therethrough positioned coincident with the disc axial axis, said aperture is sized and configured to rotatably drive the vise shaft, said disc also having an outer periphery with a corrugated surface adapted to provide a hand grip, said periphery not extending beyond the vise base and a hub including a proximal end portion and a distal end portion, said hub having a hub axial axis extending between said proximal end portion and said distal end portion, said hub proximal end portion is adjacent to said disc annular surface with the hub axial axis positioned coaxial to the disc axial axis with said hub forming an extension from said disc annular surface, said hub also includes an aperture therethrough aligned with said disc aperture therethrough, said hub distal end portion positioned to face the vise, said hub also having an outer surface not extending to said disc outer periphery between said hub proximal end portion and said hub distal end portion such that an annular recess is formed between said disc annular surface and said hub outer surface, said annular recess is operational to allow a user's hand to exert axial force on said disc annular surface away from the vise to remove said manual handle apparatus from the shaft;
(b) grasping said disc outer periphery in the user's hand;
(c) aligning said hub aperture of said hub distal end portion to the vise shaft and axially sliding said hub aperture onto the vise shaft and continuing to slide the shaft through said disc aperture until the shaft is flush with or extends beyond said disc face;
(d) spinning said disc outer periphery by grasping said disc outer periphery in the user's hand to open at least one of the plurality of vise jaws to position the vise jaws to accept the workpiece; and
(e) rotating said disc outer periphery by grasping said disc outer periphery in the user's hand to close at least one of the plurality of vise jaws to clamp the workpiece such that an amount of clamping force placed upon the workpiece is limited by a frictional grip of the user's hand on said disc periphery.

16. A method of using a manual handle apparatus according to claim 15 wherein said step of providing said manual handle apparatus further includes a means for axially retaining said manual handle apparatus to the shaft and an additional step after said aligning step further comprising engaging said means between said manual handle apparatus and the shaft being operational to retain said manual handle apparatus on the shaft.

17. A method of using a manual handle apparatus according to claim 15 wherein said step of providing said manual handle apparatus further includes a crank rotatably engaged to said disc face and wherein said step of spinning is accomplished by grasping said crank in the user's hand being operational to quickly rotate said disc and open at least one of the plurality of vise jaws to position the vise jaws to accept the workpiece.

18. A method of using a manual handle apparatus for use in selectively setting at least one of a plurality of vise jaws to clamp and unclamp a workpiece in a vise having a base utilizing a vise shaft that converts rotational motion into relative axial movement of at least one of the plurality of vise jaws, comprising the steps of:
(a) providing a manual handle apparatus that includes a disc including a disc face and a disc annular surface, said disc having a disc axial axis substantially perpendicular to said disc face, the disc axial axis being positioned in a central portion of said disc, said disc also having an outer periphery with a corrugated surface adapted to provide a hand grip, said periphery not extending beyond the vise base and a hub including a proximal end portion and a distal end portion, said hub having a hub axial axis extending between said proximal end portion and said distal end portion, said hub proximal end portion is adjacent to said disc annular surface with the hub axial axis positioned coaxial to the disc axial axis with said hub forming an extension from said disc annular surface, said hub also includes an aperture therethrough, said hub distal end portion positioned to face the vise, said hub also having an outer surface not extending to said disc outer periphery between said hub proximal end portion and said hub distal end portion such that an annular recess is formed between said disc annular surface and said hub outer surface, said annular recess is operational to allow a user's hand to exert axial force on said disc annular surface away from the vise to remove said manual handle apparatus from the shaft;
(b) grasping said disc outer periphery in the user's hand;
(c) aligning said hub aperture of said hub distal end portion to the vise shaft and axially sliding said hub aperture onto the vise shaft and continuing to slide the shaft through said hub aperture until the shaft contacts said disc;
(d) spinning said disc outer periphery by grasping said disc outer periphery in the user's hand to open at least one of the plurality of vise jaws to position the vise jaws to accept the workpiece; and
(e) rotating said disc outer periphery by grasping said disc outer periphery in the user's hand to close at least one of the plurality of vise jaws to clamp the workpiece such that an amount of clamping force placed upon the workpiece is limited by a frictional grip of the user's hand on said disc periphery.

19. A method of using a manual handle apparatus according to claim 18 wherein said step of providing said manual handle apparatus further includes a means for axially retaining said manual handle apparatus to the shaft and an additional step after said aligning step further comprising engaging said means between said manual handle apparatus and the shaft being operational to retain said manual handle apparatus on the shaft.

20. A method of using a manual handle apparatus according to claim 18 wherein said step of providing said manual handle apparatus further includes a crank rotatably engaged to said disc face and wherein said step of spinning is accomplished by grasping said crank in the user's hand being operational to quickly rotate said disc and open at least one of the plurality of vise jaws to position the vise jaws to accept the workpiece.
